(19) United States
(12) Patent Application Publication
(10) Pub. No.: US 2012/0109422 A1
(43) Pub. Date: May 3, 2012

(54) Keyless entry system for vehicle

(75) Inventor: Kenji Katou, Nishikamo-gun (JP)

(73) Assignee: DENSO CORPORATION, Kariya-city (JP)

(21) Appl. No.: 13/317,875

(22) Filed: Oct. 31, 2011

(30) Foreign Application Priority Data
Nov. 1, 2010 (JP) 2010-245347
Sep. 8, 2011 (JP) 2011-196109

(51) Int. Cl. G06F 7/00

(52) U.S. Cl. 701/2

(57) ABSTRACT

In a keyless entry system, when at least one proper portable unit is detected outside of a passenger compartment and the one is not detected inside of the passenger compartment, a door lock control is performed. Then, when it is determined that another proper portable unit is inside of the passenger compartment, the another proper portable unit is assigned to an unavailable proper portable unit. Further, it is determined whether at least one proper portable unit is inside of the passenger compartment while excluding the unavailable proper portable unit in response to an operation starting instruction to start an operation of a power source for driving the vehicle. When it is determined that no proper potable unit is inside of the passenger compartment, it is prohibited to start the operation of the power source.

### CROSS REFERENCE TO RELATED APPLICATION

This application is based on Japanese Patent Applications No. 2010-245347 filed on Nov. 1, 2010 and No.2011-196109 filed on Sep. 8, 2011, the disclosure of which are incorporated herein by reference.

### FIELD OF THE INVENTION

The present invention relates to a keyless entry system for a vehicle that authenticates multiple portable units and performs a door lock control in accordance with an authentication result.

### BACKGROUND OF THE INVENTION

A vehicle keyless device that authenticates portable units, and performs a door lock control, a door unlock control and an engine starting control depending on an authentication result has been known, for example, in JP2008-14019A, corresponding to US2009/0289759A.

Also, in a vehicle keyless device, it is known to authenticate multiple proper portable units and permits any of the multiple portable units to lock or unlock doors and to start an engine operation.

In such a keyless device, however, in a situation where one of the proper portable units is left inside of a passenger compartment, the doors can be locked by another proper portable unit carried by a user because the authentication is established with the proper portable unit carried by the user.

In such a situation, however, if an unauthorized person breaks the window glass and enters the passenger compartment, the authentication can be established with the proper portable unit left in the passenger compartment and the engine can be started. As such, the vehicle may be stolen.

Therefore, it is preferable to perform a door lock control after determining that one of the proper portable units is located outside of the passenger compartment as well as the other proper portable unit is not located inside of the passenger compartment.

In such a case, it is necessary to perform the authentication of the multiple proper portable units by successively switching antennas provided in respective positions of the vehicle and authentication areas so as to detect the position or status of each of the proper portable units, such as whether the proper portable unit exists inside of the passenger compartment or outside of the passenger compartment, and/or whether the portable unit is not detected.

However, in a structure where the door lock control is performed after the positions of all the proper portable units are detected, it takes a time to lock the doors, and hence responsiveness is degraded. Further, the responsiveness is more degraded with an increase in the number of the proper portable units.

### SUMMARY OF THE INVENTION

The present invention is made in view of the foregoing matter, and it is an object of the present invention to provide a keyless entry system for a vehicle with enhanced responsiveness in locking doors and enhanced security.

According to an aspect, a keyless entry system includes multiple proper portable units, a door lock controlling element, an unavailable portable unit assigning element and an operation start prohibiting element. The door lock controlling element determines whether at least one proper portable unit is outside of a passenger compartment of a vehicle and whether at least one proper portable unit is inside of the passenger compartment in response to a door lock control starting instruction to start the door lock control, and performs the door lock control when it is determined that at least one proper portable unit is outside of the passenger compartment and the one is not located inside of the passenger compartment. The unavailable portable unit assigning element determines whether another proper portable unit is inside of the passenger compartment after the door lock control is performed by the door lock controlling element, and assigns the another detected inside of the passenger compartment to an unavailable proper portable unit. The operation start prohibiting element determines whether at least one proper portable unit is inside of the passenger compartment while excluding the unavailable proper portable unit in response to an operation starting instruction to start an operation of a driving power source of the vehicle, and prohibits to start the operation of the driving power source when it is determined that no proper portable unit is inside of the passenger compartment.

In such a configuration, it is determined whether at least one proper portable unit is outside of the passenger compartment and whether at least one proper portable unit is inside of the passenger compartment in response to the door lock control starting instruction. When it is determined that at least one proper portable unit is outside of the passenger compartment and the one is not inside of the passenger compartment, the door lock control is performed. After the door lock control is performed, it is determined whether another proper portable unit is inside of the passenger compartment. When it is determined that the another is inside of the passenger compartment, the another is assigned to the unavailable proper portable unit. Further, it is determined whether at least one proper portable unit is inside of the passenger compartment while excluding the unavailable proper portable unit in response to the operation starting instruction to start the operation of the driving power source. When it is determined that no proper portable unit is inside of the passenger compartment, it is prohibited to start the operation of the driving power source. Accordingly, the responsiveness in locking the doors improves as well as the security improves.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a block diagram of a keyless entry system according to an embodiment of the present invention;

FIG. 2 is a schematic view illustrating authentication areas of the keyless entry system according to the embodiment;

FIGS. 3A through 3C are schematic views illustrating frames of request signals outputted from a smart entry ECU of the keyless entry system according to the embodiment;

FIG. 4 is a flowchart illustrating a processing performed by the smart entry ECU according to the embodiment;

FIG. 5 is a flowchart illustrating a processing performed by the smart entry ECU according to the embodiment;

FIG. 6 is a flowchart illustrating a processing performed by the smart entry ECU according to the embodiment; and

FIG. 7 is a flowchart illustrating a processing performed by the smart entry ECU according to the embodiment.

### DETAILED DESCRIPTION OF EXEMPLARY EMBODIMENT

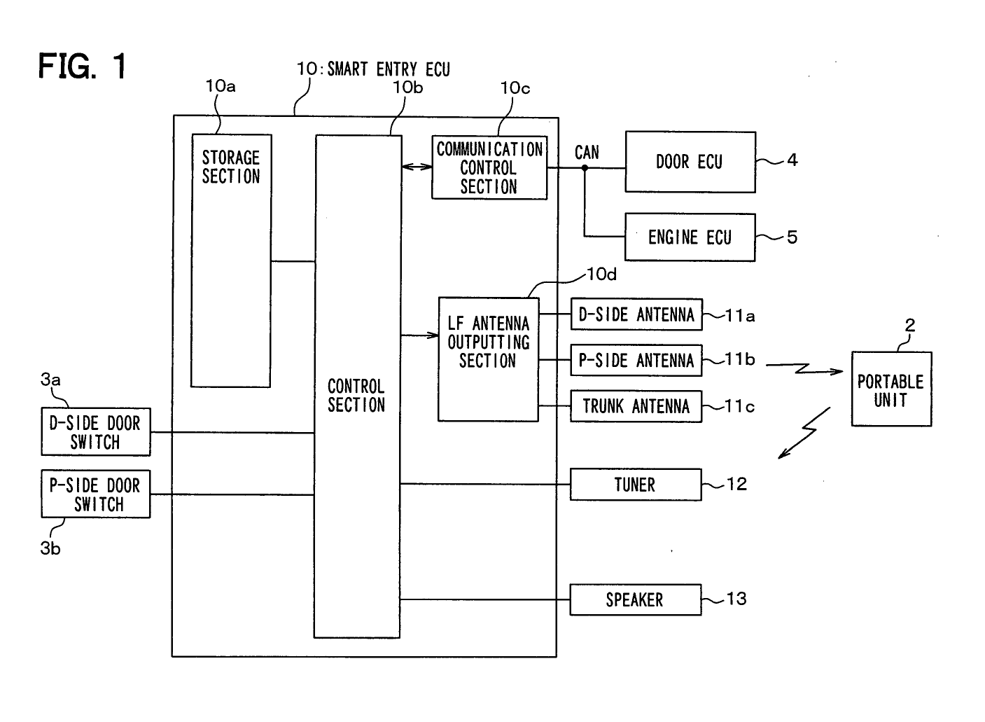

Referring to FIG. 1, a keyless entry system according to an embodiment generally includes a smart entry ECU 10, a driver seat antenna 11a, a passenger seat antenna 11b, a trunk antenna 11c, a tuner 12 and a speaker 13. The smart entry ECU 10 is connected to a driver seat door switch 3a, a passenger seat door switch 3b, a door ECU 4, and an engine ECU 5.

Hereinafter, the driver seat antenna 11a, the passenger seat antenna 11b, the driver seat door switch 3a and the passenger seat door switch 3b are also referred to as the D-side antenna 11a, the P-side antenna 11b, the D-side door switch 3a and the P-side door switch 3b, respectively. In the description and the drawings, “D-side” and “P-side” means “driver seat side” and “passenger seat side”, respectively.

The keyless entry system is mounted in a vehicle. The keyless entry system authenticates portable units 2 as electronic keys and performs a door lock control, a door unlock control, an engine starting control and the like based on an authentication result. Specifically, the authentication of the portable units 2 is performed by transmitting radio waves from the antennas 11a, 11b, 11c, which are disposed on respective positions of the vehicle, and by determining whether or not response data that is generated from the portable unit 2 in response to the radio waves is received or not.

The smart entry ECU 10 includes a storage section 10a, a control section 10b, a communication control section 10c, and a LF antenna outputting section 10d.

The storage section 10a is provided to store various data. For example, the storage section 10a includes a RAM, a ROM and an EEPRPM.

The control section 10b is provided by a computer including a CPU, an I/O part and the like. The CPU executes various processing in accordance with a program stored in the storage section 10a.

The communication control section 10c is provided to conduct communication with the door ECU 4, the engine ECU 5 and the like, which are connected through a CAN as a vehicle LAN.

The LF antenna outputting section 10d generates a LF band signal in response to a signal outputted from the control section 10b, and sends the LF band signal to the antennas 11a, 11b, 11c so that the antennas 11a, 11b, 11c generate radio waves according to the LF band signal.

The D-side antenna 11a is disposed on an inner side of a pillar that is located between a front seat and a rear seat on the driver's seat side. The P-side antenna 11b is disposed on an inner side of a pillar that is located between a front seat and a rear seat on the passenger's seat side. The trunk antenna 11c is disposed inside of a trunk. The antennas 11a, 11b, 11c are wireless transmitters that transmit radio waves in accordance with the signal generated from the smart entry ECU 10.

The tuner 12 is a device for receiving the response data transmitted from the portable unit 2.

The smart entry ECU 10 separately performs a compartment-outside authentication for authenticating the portable unit 2 located outside of the passenger compartment and a compartment-inside authentication for authenticating the portable unit 2 located inside of the passenger compartment by changing intensity of the radio waves outputted from each of the D-side antenna 11a and the P-side antenna 11b.

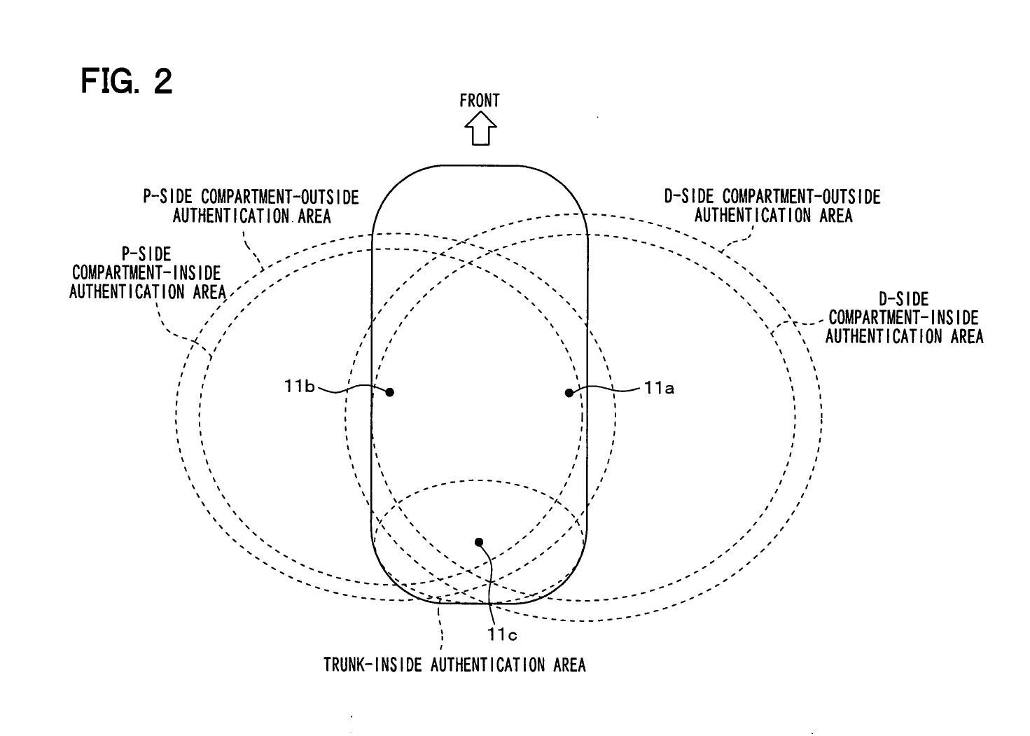

FIG. 2 illustrates authentication areas, such as a D-side compartment-outside authentication area (DOUT) for the compartment-outside authentication through the D-side antenna 11a, a D-side compartment-inside authentication area (DIN) for the compartment-inside authentication through the D-side antenna 11a, a P-side compartment-outside authentication area (POUT) for the compartment-outside authentication through the P-side antenna 11b, a P-side compartment-inside authentication area (PIN) for the compartment-inside authentication through the P-side antenna 11b, and a trunk-inside authentication area for a trunk-inside authentication through the trunk antenna 11c.

In the example of FIG. 2, when the portable unit 2 is detected in the D-side compartment-outside authentication area, and is not detected in the P-side compartment-inside area, it is determined that the portable unit 2 is located outside of the passenger compartment on the driver's seat side. When the portable unit 2 is detected in the D-side compartment-inside authentication area and in the P-side compartment-inside authentication area, it is determined that the portable unit 2 is located inside of the passenger compartment. In this way, the location of the portable unit 2 can be detected by changing the authentication areas.

The smart entry ECU 10 changes the authentication areas regularly, such as every 100 millisecond (ms), to detect the location of the portable unit 2.

The portable unit 2 is assigned with a specific key identification (ID) code. When the vehicle is supplied to a user, the ID codes of multiple portable units 2 are memorized in a memory of the smart entry ECU 10 to identify the portable units 2 as proper or authorized portable units. In the present embodiment, for example, the ID codes of two portable units 2 are memorized in the memory of the smart entry ECU 10.

Further, the smart entry ECU 10 memorizes one of the two portable units 2 as a main portable unit (e.g., main key) and the other of the two portable units 2 as a sub portable unit (e.g., sub key). The smart entry ECU 10 switches the main portable unit and the sub portable unit in accordance with a predetermined condition. That is, the smart entry ECU 10 changes the main portable unit with the sub portable unit and the sub portable unit with the main portable unit in accordance with a predetermined condition.

The smart entry ECU 10 outputs a request signal indicating the ID code of the proper portable unit 2 memorized in the memory.

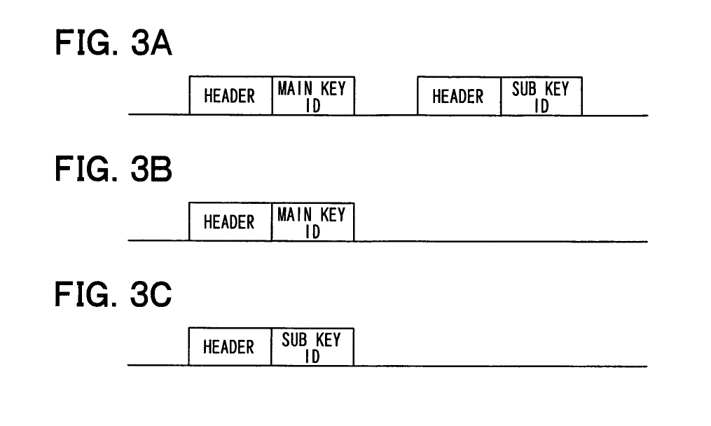

FIGS. 3A through 3C illustrate frames of the request signals outputted from the smart entry ECU 10. The smart entry ECU 10 distinctly performs an event authentication where a frame including a main key ID code of the main portable unit and a frame including a sub key ID code of the sub portable unit are successively transmitted as shown in FIG. 3A, a main portable unit limited authentication where a frame only including the main key ID code is transmitted as shown in FIG. 3B, and a sub portable unit limited authentication where a frame only including the sub key ID code is transmitted as shown in FIG. 3C.

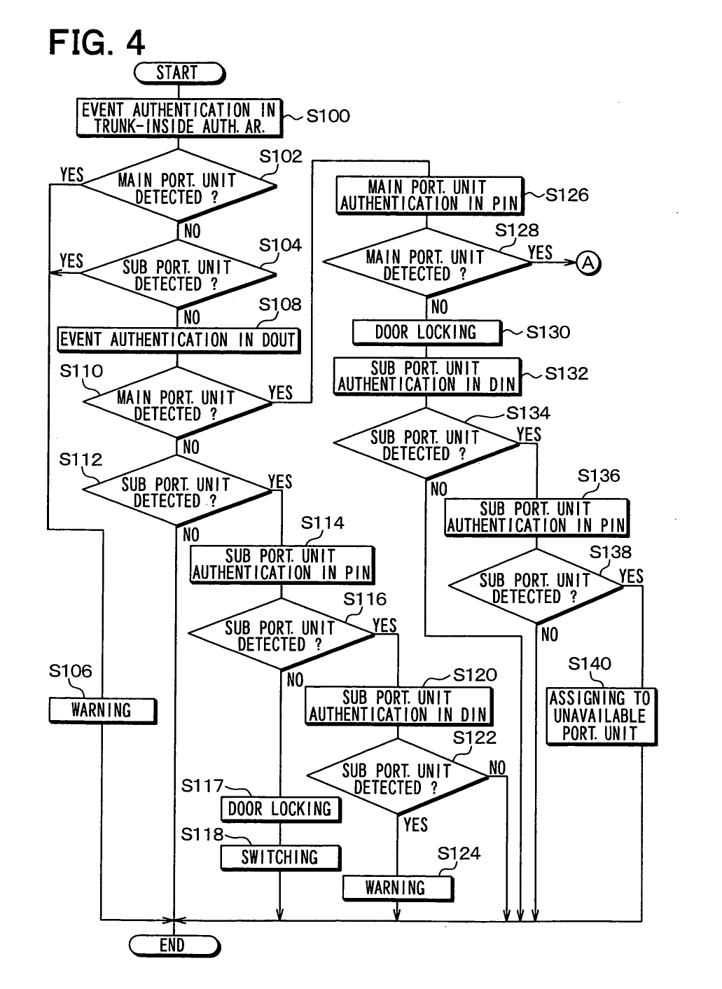

FIG. 4 is a flowchart illustrating a processing executed by the smart entry ECU 10 when the D-side door switch 3a, which is disposed in a door beside the driver's seat, is operated.

When a driver gets off the vehicle and the D-side door switch 3a is operated, a signal in accordance with the operation to the D-side door switch 3a is inputted to the smart entry ECU 10 from the D-side door switch 3a. When receiving the signal from the D-side door switch 3a, the smart entry ECU 10 executes the processing shown in FIG. 4.

At S100, the smart entry ECU 10 performs the event authentication for the trunk-inside authentication area. Specifically, the smart entry ECU 10 instructs the trunk antenna 11c to set the trunk-inside inside area as the target authentication area, and transmits the request signal through the trunk antenna 11c so that the frame including the main key ID code and the frame the sub key ID code are successively transmitted as shown in FIG. 3A. Then, the smart entry ECU 10 performs the authentication of the portable unit 2 in the trunk-inside authentication area by determining whether or not the tuner 12 receives the response signal from the portable unit 2, which is generated in response to the request signal, and whether or not the response signal includes the key ID code of the proper portable unit 2.

At S102, the smart entry ECU 10 determines whether or not the main portable unit 2 is detected in the trunk-inside authentication area based on an authentication result of S100.

At S104, the smart entry ECU 10 determines whether or not the sub portable unit 2 is detected in the trunk-inside authentication area based on the authentication result of S100.

When the main portable unit 2 is located inside of the trunk, the response signal including the key ID code is transmitted from this main portable unit 2. In this case, therefore, the smart entry ECU 10 determines that the main portable unit 2 is detected in the trunk, corresponding to “YES” at S102. Then, at S106, the smart entry ECU 10 warns the user that the main portable unit 2 is left in the trunk. For example, a buzzing sound is generated from the speaker 13 for warning. Thereafter, the smart entry ECU 10 terminates the processing.

When the sub portable unit 2 is located inside of the trunk, the response signal including the key ID code is transmitted from this sub portable unit 2. In this case, therefore, the smart entry ECU 10 determines that the sub portable unit 2 is detected in the trunk, corresponding to “YES” at S104. Then, at S106, the smart entry ECU 10 warns the user that the sub portable unit 2 is left in the trunk. Thereafter, the smart entry ECU 10 terminates the processing.

When both the main portable unit 2 and the sub portable unit 2 are not located in the trunk, the determination result of S102 and the determination result of S104 correspond to “NO”. In this case, at S108, the smart entry ECU 10 performs the event authentication for the D-side compartment-outside authentication area.

Specifically, the smart entry ECU 10 instructs the D-side antenna 11a to set the D-side compartment-outside authentication area as the target authentication area and transmits the request signal through the D-side antenna 11a so that the frame including the main key ID code and the frame including the sub key ID code are successively transmitted as shown in FIG. 3A. Then, the smart entry ECU 10 determines whether or not the tuner 12 receives the response signal that is generated from the portable unit 2 in response to the request signal and whether or not the response signal includes the key ID code of the proper portable unit 2. In this way, the smart entry ECU 10 performs the event authentication for the D-side compartment-outside authentication area.

At S110, the smart entry ECU 10 determines whether or not the main portable unit 2 is detected in the D-side compartment-outside authentication area based on an authentication result of S108.

At S112, the smart entry ECU 10 determines whether or not the sub portable unit 2 is detected in the D-side compartment-outside area based on the authentication result of S108.

When both the main portable unit 2 and the sub portable unit 2 are not detected, a determination result of S110 indicates “NO” and a determination result of S112 indicates “NO”. In this case, the smart entry ECU 10 terminates the processing without performing a door lock control.

When the main portable unit 2 is not detected in the D-side compartment-outside authentication area and the sub portable unit 2 is detected in the D-side compartment-outside authentication area, the determination result of S110 corresponds to “NO” and the determination result of S112 corresponds to “YES”. In this case, at S114, the smart entry ECU 10 performs the sub portable unit limited authentication for the P-side compartment-inside authentication area. Specifically, the smart entry ECU 10 instructs the P-side antenna 11b to set the P-side compartment-inside authentication area as the target authentication area, and transmits the request signal through the P-side antenna 11b so that the frame including the sub key ID code is transmitted as shown in FIG. 3C.

Next, at S116, the smart entry ECU 10 determines whether or not the sub portable unit 2 is detected in the P-side compartment-inside authentication area. When the sub portable unit 2 is not detected in the P-side compartment-inside authentication area, a determination result of S116 corresponds to “NO”. Then, at S117, the smart entry ECU 10 performs the door lock control for locking the doors of the vehicle. Specifically, the smart entry ECU 10 generates information to instruct the door ECU 4 to lock the doors. Thus, the doors are locked.

Next, at S118, the smart entry ECU 10 switches the main portable unit 2 and the sub portable unit 2. Specifically, the smart entry ECU 10 permits the memory to memorize the main portable unit 2 as the sub portable unit 2 and the sub portable unit 2 as the main portable unit 2. Then, the smart entry ECU 10 terminates the processing.

In this way, when the main portable unit 2 is not detected in the D-side compartment-outside authentication area and the sub portable unit 2 is detected in the P-side compartment-inside area, the door lock control is performed and the sub portable unit 2 is switched to the main portable unit 2.

When the sub portable unit 2 is detected in the P-side compartment-inside authentication area, corresponding to “YES” at S116, the smart entry ECU 10 performs the sub portable unit limited authentication for the D-side compartment-inside authentication area at S120. Specifically, the D-side compartment-inside authentication area shown in FIG. 2 is set to the target authentication area, and the frame including the sub key ID code shown in FIG. 3C is transmitted.

Next, at S122, the smart entry ECU 10 determines whether or not the sub portable unit 2 is detected in the P-side compartment-inside authentication area. When the sub portable unit 2 is detected in the P-side compartment-inside authentication area, a determination result of S122 corresponds to “YES”.

Then, at S124, the smart entry ECU 10 warns the user that the portable unit 2 is left in the passenger compartment. For example, the smart entry ECU 10 permits the speaker 13 to generate the buzzing sound, and then terminates the processing.

In this way, when the main portable unit 2 is not detected in the D-side compartment-outside authentication area and the sub portable unit 2 is detected in both the P-side compartment-inside authentication area and the D-side compartment-inside authentication area, the warning is performed.

When the sub portable unit 2 is not detected in the D-side compartment-inside authentication area at S122, a determination result of S122 corresponds to “NO”. In this case, the smart entry ECU 40 terminates the processing without performing the door lock control.

When the main portable unit 2 is detected in the D-side compartment-outside area at S110, the determination result of S110 indicates “YES”. Then, at S126, the smart entry ECU 10 performs the main portable unit limited authentication for the P-side compartment-inside authentication area. Specifically, the P-side compartment-inside authentication area shown in FIG. 2 is set to the target authentication area, and the frame including the main key ID shown in FIG. 3B is transmitted.

At S128, the smart entry ECU 10 determines whether or not the main portable unit 2 is detected in the P-side compartment-inside authentication area. When the main portable unit 2 is not detected in the P-side compartment-inside authentication area, a determination result of S128 corresponds to “NO”. Then, at S130, the door lock control is performed.

Next, at S132, the smart entry ECU 10 performs the sub portable unit limited authentication for the D-side compartment-inside authentication area. Specifically, the D-side compartment-inside authentication area shown in FIG. 2 is set to the target authentication area, and the frame including the sub key ID shown in FIG. 3C is transmitted.

At S134, the smart entry ECU 10 determines whether or not the sub portable unit 2 is detected in the D-side compartment-inside authentication area. When the sub portable unit 2 is not detected in the D-side compartment-inside authentication area, the smart entry ECU 10 terminates the processing without performing the door lock control.

When the sub portable unit 2 is detected in the D-side compartment-inside authentication area at S134, a determination result of S134 corresponds to “YES”. Then, at S136, the smart entry ECU 10 performs the sub portable unit limited authentication for the P-side compartment-inside authentication area. Specifically, the P-side compartment-inside authentication area shown in FIG. 2 is set to the target authentication area, and the frame including the sub key ID shown in FIG. 3C is transmitted.

At S138, the smart entry ECU 10 determines whether or not the sub portable unit 2 is detected in the P-side compartment-inside authentication area. When the sub portable unit 2 is detected in the P-side compartment-inside authentication area at S138, the smart entry ECU 10 assigns the sub portable unit 2 to an unavailable portable unit that is unavailable in the authentication for the engine start control and the door unlock control at S140. Specifically, the smart entry ECU 10 permits the memory to memorize that the sub portable unit 2 is the unavailable portable unit, and then terminates the processing.

The smart entry ECU 10 excludes the unavailable portable unit 2 memorized in the memory from an authentication target in the authentication for the engine start control. Although not illustrated, the smart entry ECU 10 performs a processing to return the unavailable portable unit 2, which was excluded from the authentication target, to the authentication target, that is, to an available portable unit 2 after the door unlock control is performed.

In this way, when the main portable unit 2 as the main key is detected in the D-side compartment-outside authentication area, the door lock control is performed before the authentication of S132 and S136 for detecting the sub portable unit 2 is performed so as to improve responsiveness in locking the doors.

In such a case, however, there is a possibility that the sub portable unit 2 is left in the passenger compartment. If an unauthorized person gets in the vehicle by broking a window, the engine can be started since the authentication can be established with the portable unit left in the passenger compartment. As a result, the vehicle will be stolen.

Therefore, the sub portable unit 2 is assigned to the unavailable portable unit that is not used in the authentication for the engine start control and the door unlock control. As such, it is less likely that the engine will be started by the sub portable unit 2 left in the passenger compartment.

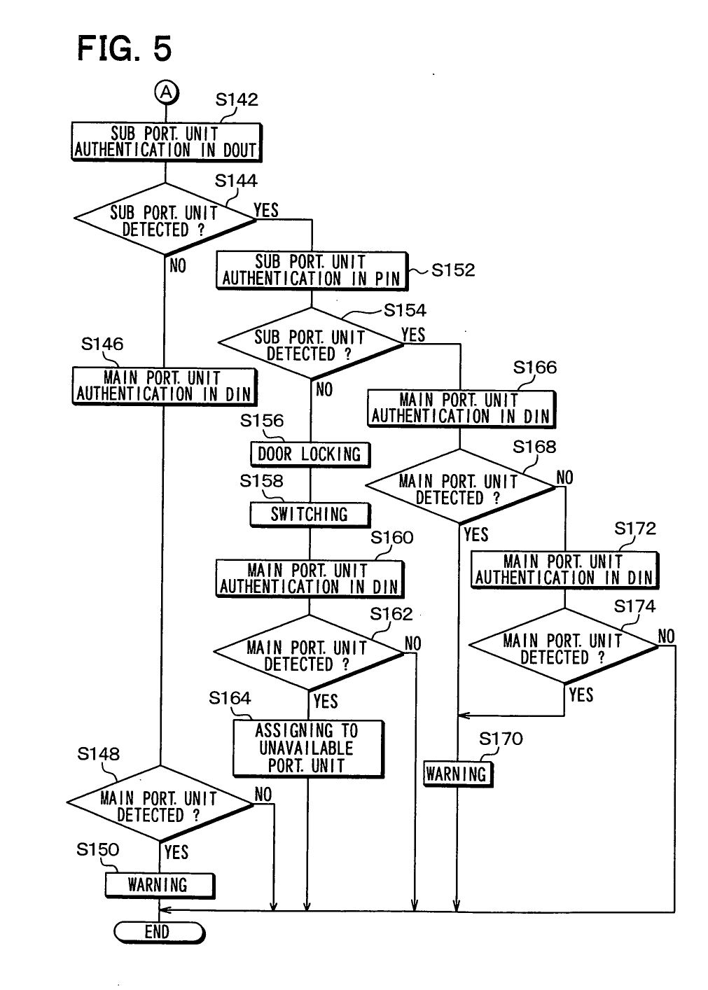

When the main portable unit 2 is detected in the D-side compartment-outside authentication area at S110, the main portable unit limited authentication is performed at S126. Further, when the main portable unit 2 is detected in the P-side compartment-inside authentication area at S128, the sub portable unit limited authentication is performed for the D-side passenger-outside authentication area at S142, as shown in FIG. 5. Specifically, the D-side compartment-outside authentication area shown in FIG. 2 is set to the target authentication area and the frame including the sub key ID shown in FIG. 3C is transmitted.

At S144, the smart entry ECU 10 determines whether or not the sub portable unit 2 is detected in the D-side compartment-outside authentication area. When the sub portable unit 2 is not detected in the D-side compartment-outside authentication area, a determination result of S144 corresponds to “NO”. In this case, at S146, the smart entry ECU 10 performs the main portable unit limited authentication for the D-side compartment-inside authentication area. Specifically, the D-side compartment-inside authentication area shown in FIG. 2 is set to the target authentication area, and the frame including the main key ID shown in FIG. 3B is transmitted.

At S148, the smart entry ECU 10 determines whether or not the main portable unit 2 is detected in the D-side compartment-inside authentication area. When the main portable unit 2 is detected in the D-side compartment-inside authentication area, a determination result of S148 corresponds to “YES”. In this case, at S150, the smart entry ECU 10 performs the warning. Specifically, the buzzing sound is generated from the speaker 13 for notifying the user that the portable unit 2 is left in the passenger compartment. Then, the smart entry ECU 10 terminates the processing.

In this way, when the main portable unit 2 is detected in the D-side compartment-outside authentication area, P-side compartment-inside authentication area and the D-side compartment-inside authentication area, and the sub portable unit 2 is detected in the D-side compartment-outside authentication area, the warning for notifying that the main portable unit 2 is left in the passenger compartment is performed.

When the main portable unit 2 is not detected at S148, the determination result of S148 corresponds to “NO”. In this case, the smart entry ECU 10 terminates the processing without performing the door lock control.

When the sub portable unit 2 is detected at S144, the determination result of S144 corresponds to “YES”. In this case, at S152, the smart entry ECU 10 performs the sub portable unit limited authentication for the P-side compartment-inside authentication area. Specifically, the P-side compartment-inside authentication area shown in FIG. 2 is set to the target authentication area, and the frame including the sub key ID shown in FIG. 3C is transmitted.

Next, at S154, the smart entry ECU 10 determines whether or not the sub portable unit 2 is detected. When the sub portable unit 2 is not detected, a determination result of S154 corresponds to “NO”. In this case, at S156, the smart entry ECU 10 performs the door lock control. Specifically, information for instructing to lock the doors is transmitted to the door ECU 4. Thus, the doors are locked.

In this way, when the main portable unit 2 is detected in the D-side compartment-outside authentication area, the P-side compartment-inside authentication area and the D-side compartment-inside authentication area, and the sub portable unit 2 is detected in the D-side compartment-outside authentication area and not detected in the P-side compartment-inside authentication area, the door lock control is performed before the authentication of S162 for detecting the main portable unit 2 is performed.

Next, at S158, the smart entry ECU 10 switches the main portable unit 2 and the sub portable unit 2. Specifically, the smart entry ECU 10 permits the memory to memorize the sub portable unit 2 as the main portable unit 2 and the main portable unit 2 as the sub portable unit 2.

At S160, the smart entry ECU 10 performs the main portable unit limited authentication for the D-side compartment-inside authentication area. Specifically, the D-side compartment-inside authentication area shown in FIG. 2 is set to the target authentication area, and the frame including the sub key ID shown in FIG. 3C is transmitted.

At S162, the smart entry ECU 10 determines whether or not the main portable unit 2 is detected. When the main portable unit 2 is detected at S162, a determination result of S162 corresponds to “YES”. Then, at S164, the smart entry ECU 10 assigns the main portable unit 2 to the unavailable portable unit that is not used in the authentication for the engine start control and the door unlock control. Specifically, the smart entry ECU 10 permits the memory to memorize that the main portable unit 2 is the unavailable portable unit for the authentication, and then terminates the processing.

In this way, since the main portable unit 2 is excluded from the authentication target of the authentication for the engine starting control, it is less likely that the engine will be started by the main portable unit 2 that is left in the passenger compartment.

When the main portable unit 2 is not detected at S162, the determination result of S162 corresponds to “NO”. In this case, the smart entry ECU 10 terminates the processing without performing the door lock control.

When the sub portable unit 2 is detected at S154, the determination result of S154 corresponds to “YES”. In this case, at S166, the smart entry ECU 10 performs the main portable unit limited authentication for the D-side compartment-inside authentication area. Specifically, the D-side compartment-inside authentication area shown in FIG. 2 is set to the target authentication area, and the frame including the main key ID shown in FIG. 3B is transmitted.

At S168, it is determined whether or not the main portable unit 2 is detected. When the main portable unit 2 is detected at S168, a determination result of S168 corresponds to “YES”. In this case, at S170, the smart entry ECU 10 performs the warning to notify the user that the portable unit 2 is left in the passenger compartment. Specifically, the buzzing sound is generated from the speaker 13 to notify the user of the portable unit 2 being left in the passenger compartment, and then the processing is terminated.

When the main portable unit 2 is not detected, the determination result of S168 corresponds to “NO”. In this case, at S172, the smart entry ECU 10 performs the main portable unit limited authentication for the D-side compartment-inside authentication area. Specifically, the D-side compartment-inside authentication area shown in FIG. 2 is set to the target authentication area, and the frame including the main key ID shown in FIG. 3B is transmitted.

Next, at S174, the smart entry ECU 10 determines whether or not the main portable unit 2 is detected. When the main portable unit 2 is detected at 174, a determination result of S174 corresponds to “YES”. In this case, at S170, the smart entry ECU 10 performs the warning for notifying the user that the portable unit 2 is left in the passenger compartment.

When the main portable unit 2 is not detected, the determination result of S174 corresponds to “NO”. In this case, the smart entry ECU 10 terminates the processing without performing the door lock control.

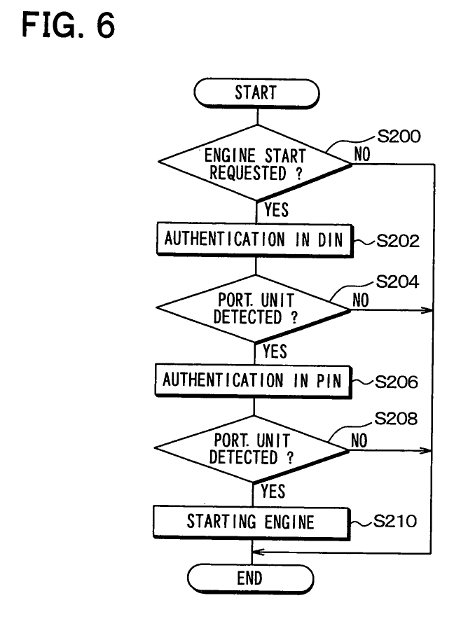

FIG. 6 is a flowchart illustrating a processing for the engine start control. The smart entry ECU 10 regularly executes the processing shown in FIG. 6.

First, at S200, the smart entry ECU 10 determines whether or not there is an engine start request for starting the engine. Specifically, the smart entry ECU 10 performs the determination based on a signal indicative of a request for starting the engine, which is generated from a start switch in response to a driver's operation of the start switch.

When the signal indicative of the engine start request is not generated from the start switch, a determination result of S200 corresponds to “NO”. In this case, the smart entry ECU 10 terminates the processing. When the signal indicative of the engine start request is generated from the start switch in response to the driver's operation of the start switch, the determination result of S200 corresponds to “YES”. Then, at S202, the smart entry ECU 10 performs the authentication of the portable unit 2 in the D-side compartment-inside authentication area. In this authentication, the smart entry ECU 10 refers to the memory and excludes the proper portable unit 2 that is assigned to the unavailable portable unit from the authentication target. For example, in a case where the main portable unit 2 is assigned to the unavailable portable unit, the authentication is performed while excluding the main portable unit 2 from the authentication target.

Next, at S204, the smart entry ECU 10 determines whether or not the proper portable unit 2 is detected based on an authentication result of S202.

When the proper portable unit 2 is not detected at S204, a determination result of S204 corresponds to “NO”. In this case, the smart entry ECU 10 terminates the processing. When the proper portable unit 2 is detected, the determination result of S204 corresponds to “YES”. In this case, at S206, the smart entry ECU 10 performs the authentication for the P-side compartment-inside authentication area. In this authentication, the smart entry ECU 10 refers to the memory and excludes the proper portable unit 2 that is assigned to the unavailable portable unit from the authentication target.

Next, at S208, the smart entry ECU 10 determines whether or not the proper portable unit 2 is detected based on an authentication result of S206.

When the portable unit 2 is not detected at S208, a determination result of S208 corresponds to “NO”. In this case, the smart entry ECU 10 terminates the processing. When the portable unit 2 is detected at S208, the determination result of S208 corresponds to “YES”. In this case, at S210, the smart entry ECU 10 instructs the engine ECU 5 to perform the engine start control, and then terminates the processing. The engine ECU 5 starts the engine in response to this instruction from the smart entry ECU 10.

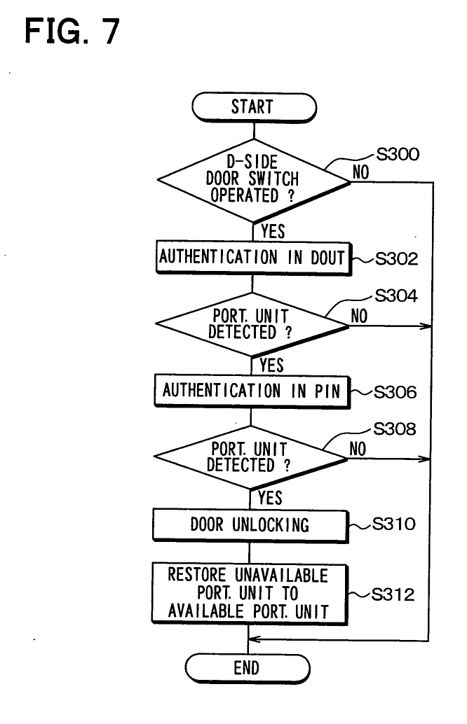

FIG. 7 is a flowchart illustrating a processing for the door lock control. The smart entry ECU 10 regularly executes the processing shown in FIG. 7.

At S300, the smart entry ECU 10 determines whether or not the D-side door switch 3a is operated. Specifically, the smart entry ECU 10 determines the operation of the D-side door switch 3a based on a signal indicative of the operation of the D-side door switch 3a, which is generated from the D-side door switch 3a in response to the user's (e.g., driver's) operation of the D-side door switch 3a.

When the signal indicative of the user's operation is not generated from the D-side door switch 3a, a determination result of S300 corresponds to “NO”. In this case, the smart entry ECU 10 terminates the processing. When the signal indicative of the user's operation is inputted from the D-side door switch 3a in response to the user's operation of the D-side door switch 3a, the determination result of S300 corresponds to “YES”. Then, at S302, the smart entry ECU 10 performs the authentication of the portable unit 2 in the D-side compartment-outside authentication area. In this authentication, the smart entry ECU 10 refers to the memory and excludes the proper portable unit 2 that is assigned to the unavailable portable unit from the authentication target. For example, in a case where the main portable unit 2 is assigned to the unavailable portable unit, the authentication is performed while excluding the main portable unit 2 from the authentication target.

Next, at S304, the smart entry ECU 10 determines whether or not the portable unit 2 is detected based on an authentication result of S302.

When the proper portable unit 2 is not detected, a determination result of S304 corresponds to “NO”. In this case, the smart entry ECU 10 terminates the processing. When the proper portable unit 2 is detected, the determination result of S304 corresponds to “YES”. Then, at S306, the smart entry ECU 10 performs the authentication of the portable unit 2 for the P-side compartment-inside authentication area. In this authentication, the smart entry ECU 10 refers to the memory and excludes the proper portable unit 2 that is assigned to the unavailable portable unit from the authentication target.

Next, at S308, the smart entry ECU 10 determines whether or not the proper portable unit 2 is detected based on an authentication result of S306.

When the proper portable unit 2 is not detected, a determination result of S308 corresponds to “NO”. In this case, the smart entry ECU 10 terminates the processing. When the proper portable unit 2 is detected, the determination result of S308 corresponds to “YES”. Then, at S310, the smart entry ECU 10 performs the unlock control. Specifically, the smart entry ECU 10 instructs the door ECU 4 to unlock the doors.

Thus, the door ECU 4 unlocks the doors in response to the instruction from the smart entry ECU 10.

Next, at S312, the smart entry ECU 10 restores the proper portable unit 2 that has been assigned to the unavailable portable unit to the authentication target, that is, to the available condition. Specifically, the smart entry ECU 10 permits the memory to delete the information memorized at S140 that the proper portable unit 2 is assigned to the unavailable portable unit, and then terminates the processing.

In the above-described configuration, the compartment-outside authentication to authenticate a proper portable unit 2 outside of the passenger compartment and the compartment-inside authentication to authenticate a proper portable unit 2 inside of the passenger compartment are performed in response to a door lock control starting instruction to start the door lock control. When it is determined that at least one proper portable unit 2 is outside of the passenger compartment and the one is not located inside of the passenger compartment, the door lock control is performed.

After the door lock control is performed, the compartment-inside authentication for another proper portable unit 2 is performed. When it is determined that another proper portable unit 2 is inside of the passenger compartment, the another proper portable unit 2 detected inside of the passenger compartment is assigned to the unavailable portable unit.

Further, when an operation starting instruction to start an operation of a driving power source of the vehicle is generated, the compartment-inside authentication is performed while excluding the unavailable proper portable unit that is located inside of the passenger compartment from the authentication target. When it is determined that no proper portable unit 2 other than the unavailable proper portable unit is inside of the passenger compartment, it is prohibited to start the operation of the driving power source. Accordingly, the responsiveness in locking the doors improves as well as the security improves.

The door lock control is performed before it is determined whether another proper portable unit 2 is inside of the passenger compartment. Therefore, the responsiveness in locking the doors further improves.

The compartment-outside authentication is performed in response to a door unlock instruction to unlock the doors. When it is determined that at least one proper portable unit 2 is outside of the passenger compartment by the compartment-outside authentication, the door unlock control is performed, and the unavailable proper portable unit is restored to the authentication target, that is, restored to the available proper portable unit. Therefore, the proper portable unit 2, which was assigned to the unavailable portable unit once, can realize the function as the proper portable unit 2.

The compartment-outside authentication is performed while excluding the unavailable proper portable unit. Therefore, it is less likely that the authentication will be established by the portable unit left in the passenger compartment in the compartment-outside authentication, and the door unlock control will be performed by the portable unit left in the passenger compartment.

The exemplary embodiment is described hereinabove. However, the present invention is not limited to the above-described exemplary embodiment, but may be implemented in various other ways without departing from the spirit of the invention.

For example, in the above-described exemplary embodiment, the keyless entry system is employed to the vehicle having the engine as the driving power source. Alternatively, the keyless entry system can be employed to any other-types of a vehicle. For example, the keyless entry system can be employed to a hybrid vehicle having an engine and a motor as the driving power source, and an electric vehicle having a motor as the driving power source.

In the above-described exemplary embodiment, the two portable units, such as the main portable unit and the sub portable unit, are employed as the proper portable units. Alternatively, the above-described configuration may be adaptable to a system having three or more proper portable units.

In the above-described exemplary embodiment, for example, a section achieving S108, S110, S126, S128, and S130 and the like corresponds to a door lock controlling means or element. A section achieving S132, S134, S136, S138 and S140 corresponds to an unavailable portable unit assigning means or element. A section achieving S300 through S312 corresponds to a door unlock control means or element. Also, a section achieving S106, S124, S150 and S170 corresponds to a notifying means or element. A section achieving S200 through S210 corresponds to an operation start prohibiting means or element.

Additional advantages and modifications will readily occur to those skilled in the art. The invention in its broader term is therefore not limited to the specific details, representative apparatus, and illustrative examples shown and described.

What is claimed is:

1. A keyless entry system for performing a door lock control of a vehicle by authenticating a plurality of proper portable units, comprising:
a door lock controlling element that determines whether at least one proper portable unit is outside of a passenger compartment of the vehicle and whether at least one proper portable unit is inside of the passenger compartment in response to a door lock control starting instruction to start the door lock control, and performs the door lock control when it is determined that at least one proper portable unit is outside of the passenger compartment and the one is not located inside of the passenger compartment;
an unavailable portable unit assigning element that determines whether another proper portable unit is inside of the passenger compartment after the door lock control is performed by the door lock controlling element, and assigns the another detected inside of the passenger compartment to an unavailable proper portable unit; and
an operation start prohibiting element that determines whether at least one proper portable unit is inside of the passenger compartment while excluding the unavailable proper portable unit in response to an operation starting instruction to start an operation of a driving power source of the vehicle, and prohibits to start the operation of the driving power source when it is determined that no proper portable unit is inside of the passenger compartment.

2. The keyless entry system according to claim 1, wherein the door lock controlling element performs the door lock control before the unavailable portable unit assigning element determines whether another proper portable unit is inside of the passenger compartment.

3. The keyless entry system according to claim 1, further comprising:
a door unlock controlling element that determines whether at least one proper portable unit is outside of the passenger compartment in response to a door unlock instruction, and performs a door unlock control and restores the unavailable proper portable unit to an available proper portable unit when it is determined that at least one proper portable unit is outside of the passenger compartment.

4. The keyless entry system according to claim 3, wherein the door unlock controlling element determines whether at least one proper portable unit is outside of the passenger compartment while excluding the unavailable portable unit.

5. The keyless entry system according to claim 1, further comprising:
a notifying element that notifies a user of the another proper portable unit being left inside of the passenger compartment when it is determined that the another proper portable unit is inside of the passenger compartment after the door lock control is performed.
